(19) United States
(12) Patent Application Publication
(10) Pub. No.: US 2007/0150431 A1
(43) Pub. Date: Jun. 28, 2007

(54) Method and apparatus for handling a group of at least one data object

(75) Inventors: Robert Jochemsen, Eindhoven (NL); Johannes Henricus Maria Korst, Eindhoven (NL); Hong R. Li, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., EINDHOVEN (NL)

(21) Appl. No.: 10/595,765

(22) PCT Filed: Dec. 1, 2004
(86) PCT No.: PCT/IB04/52614

§ 371 Date: May 10, 2006

(30) Foreign Application Priority Data
Dec. 3, 2003 (EP) 03104527.1

(51) Int. Cl. G06F 17/30

(52) U.S. Cl. 707/1

(57) ABSTRACT

The invention relates to real-time handling of data in more in particular, estimation of time needed to retrieve frames for video rendering, taking fragmentation of frames into account. Especially for data retrieval for trick-play, this is non-trivial, as it is not known on beforehand whether the frames to be retrieved are fragmented. Retrieval of non contiguously fragmented frames takes at least twice as much time as retrieval of a non-fragmented frame. The invention provides various advantageous embodiments, taking into account that when allocation units are substantially larger than the size of frames to be retrieved. An embodiment of the invention provides a method for accurate retrieval time estimation when trick play speed, allocation unit size, frame size and logical data distance between frames to retrieve is known.

The invention relates to a method of handling a group of at least one data object.

The invention further relates to an apparatus for handling a group of at least one data object

The invention also relates to a computer programme product enabling a computer to be programmed to execute a method of handling a group of at least one data object.

Furthermore, the invention relates to a record carrier carrying such computer programme product.

The invention also relates to a programmed computer, programmed to execute a method of handling a group of at least one data object.

The paper “Disk scheduling for variable-rate data streams” at the European Workshop on Interactive Distributed Multimedia Systems and Telecommunication Services in 1997 discloses a method of scheduling of data requests for multiple data streams for real-time processing.

Real-time processing of data is necessary when for example retrieving a video stream for rendering. Video data has to be provided in time to the rendering unit to ensure proper reproduction of the video data. When data is not retrieved in time, the result may be hiccups in the reproduced video data. When multiple streams are retrieved simultaneously from one storage device, various data handling requests (or file requests; high level requests for large chunks of data like files or major segments of stream of audio visual data; these specifications are mutually exchangeable within the context of this application) have to be handled at real time and scheduling is even more important.

The paper mentioned discloses a formula for calculating an upper boundary of an amount of time necessary for fetching a data block for each of the data streams in a sweep of a reading head over a disk. This formula is:

$${T}_{s} = \frac{{\sum }_{j ∈ U} {B}_{j}}{r} + s ( n + 1 ) \qquad Expression A$$

Wherein:
U is a set of n users (or data streams);
Bⱼ is the size of the j^{th} data block to handle, i.e. to either store or retrieve;
r is the data transfer rate; and
s(n+1) is a switch time function for n users.

This formula takes into account the size of the blocks to be retrieved, the data rate of the harddisk and a switch time function. The latter is a function to calculate the time that is maximally spent on switching of the reading head while fetching a data block for each of the data streams.

This paper, however, does not specify the actual form of the switch time function. This time function is important, as switching time makes up a significant amount of harddisk drive usage time; improper scheduling could easily waste 90% of HDD time on the switch overhead. Furthermore, when the data chunks or blocks to be retrieved are stored in multiple allocation units in which harddisk drives are usually divided, the switch time increases when the allocation units are not contiguously located on the disk. The paper, however, does not disclose what impact possible fragmentation of data blocks to retrieve has on the service time or retrieval time of the data block from the disk drive.

It is an object of the invention to provide a method of scheduling and execution of data handling requests, wherein the scheduling takes into account the impact of fragmentation of data object to be handled on the retrieval time. To achieve this object, the invention provides a method of handling a group of at least one data object by issuing a data handling request to be processed by a storage device organised in allocation units by execution of at least one storage device request in a pre-determined data handling period, the method comprising the steps of: determining the number of data objects to be handled in the data handling period; determining an upper boundary for the number of allocation units involved for the data handling request; determining an upper boundary for the number of storage device requests by multiplying the number of data handling requests as determined in the first step and the upper boundary of the number of allocation units involved; determining an upper boundary for an amount of time consumed by execution of the data handling request for handling the data objects during the data handling period by determining the amount of time needed for execution of the number of storage device requests as determined in the previous step; reserving an amount of time as determined in the previous step in a data handling period for execution of the storage device requests; and handling the data objects by executing the storage device requests.

Usually, storage devices like harddisks are divided in allocation units. For retrieval of data from one allocation unit, one storage device request is needed. Data from contiguous allocation units can usually be retrieved by one storage device request as well. When allocation units from which data has to be retrieved are non-contiguous, multiple storage device requests are necessary for execution of one data handling request, wherein the data handling request relates to all data that has to be retrieved.

The data handling request is issued by an application that needs the data to be handled (either to be written or retrieved). The translation from data handling requests to storage device requests is usually done by a file system in a layer below a layer in which the application is run.

When data objects are smaller than the size of an allocation unit, a data object is stored in one allocation unit, stored in two contiguous allocation units or stored fragmented over at most two allocation units. This means that for retrieval of one data object, at most two storage device requests have to be executed.

When on the other hand the size of the data object is significantly larger than the size of one allocation unit, the maximum number of storage device requests to be executed for executing one data handling request for retrieval of the data object is larger than two. One approach to determine the maximum number of storage device requests to be executed for retrieval of the data object is to divide the size of the data object by the size of one allocation unit.

Another approach is to keep a list of fragmentation of data objects. When a data object has to be handled and the size of the data object is larger than the size of one allocation unit, the list is checked for possible fragmentation. When the data object is stored in fragments, the number of non-contiguous data areas, possibly comprising multiple contiguous allocation units, is retrieved from the list. This number is the amount of storage device requests that has to be executed for execution of the data handling request.

To determine an upper boundary for an amount of time consumed by execution of the data handling request for handling the data objects during the data handling period, the amount of time needed for execution of the number of storage device requests has to be determined. For this, also the switching time has to be taken into account. The advantage of the method according to the invention is that the switch time function can be simplified. In the approach of the prior art, the fragmentation of data objects in the storage device has to be taken into account for determining the switching time, because a reading unit has to switch from one area where data related to the data object to be handled is located (or will be located in case of a writing process) to another in case of fragmented storage of the data object. With the method according to the invention, fragmentation of data is already taken into account in the number of storage device requests to be handled.

In an embodiment of the method according to the invention, the maximum size of the data objects is substantially smaller than the size of allocation units; the data objects are stored non-contiguously at a substantially equal logic distance from each other such that multiple data objects can be stored in one allocation unit; the step of determining an upper boundary for the number of allocation units involved per data handling request is replaced by the step of determining an upper boundary of the number of data objects determined in step a) of claim 1 spaced at the substantially equal logic distance that is stored fragmented; and the step of determining an upper boundary for the number of storage device requests is replaced by the step of taking the sum of the number of file requests and the number of data objects determined in step c) of claim 2.

The logic distance between data objects is measured in bits or bytes, as to discriminate it from the spatial distance on for example a disk platter, a semiconductor crystal or other storage medium.

An advantage of this embodiment is that in this way, a more accurate and usually lower estimation can be made of the time required for execution of a data handling request. As this is usually also the time reserved while scheduling the execution of the data handling request, more data handling requests can be scheduled in the same amount of time, compared to the prior art. This means that with this embodiment of the method according to the invention, more data can be handled.

In another embodiment of the method according to the invention, the data objects are video frames comprised by a stream of audiovisual data; these frames are either inter-coded of intra-coded and the data objects to which the data handling request are related are at least some of the intra-coded frames.

Applying the method according to the invention of the embodiment of claim 2 is especially advantageous, as usually the distance between the intra-coded frames is known or at least an upper bound is known when the coding (compression) ratio of the stream of audiovisual data is known, as well as the size of the intra-coded frames. This means that during scheduling and data handling, no additional calculations or measurements have to be performed for determining these entities.

In yet another embodiment of the invention, the step of ‘determining an upper boundary for an amount of time consumed by execution of the data handling requests for handling the data objects during one data handling period by determining the amount of time needed for execution of the upper boundary for the number of storage device requests as determined in the previous step’ comprises the step of multiplying the upper boundary for the number of storage device requests by an amount of time consumed by a storage device request.

This embodiment provides a major advantage in the fact that just a simple multiplication operation is performed to determine the amount of time that will be consumed by the data handling. This can be done a lot faster and does not require fancy algorithms needed for precisely locating data on the disk to exactly determine switch times. However, this embodiment is less accurate.

The computer programme product according to the invention enables a computer to be programmed to execute the method according to claim 1.

The record carrier according to the invention carries computer programme product according to claim 14.

The programmed computer according to the invention is enabled to execute the method according to claim 1.

The invention will be elucidated by a description of embodiments which will be described by means of Figures, wherein

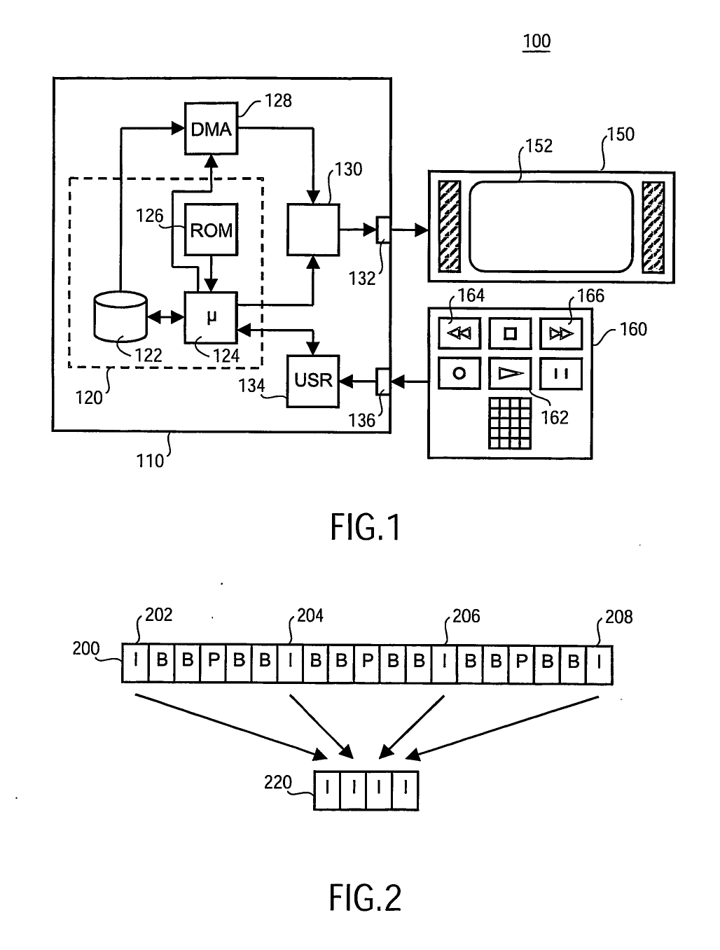

FIG. 1 illustrates an embodiment of the apparatus according to the invention;

FIG. 2 illustrates how a trickplay stream is formed from a stream of audio-visual data;

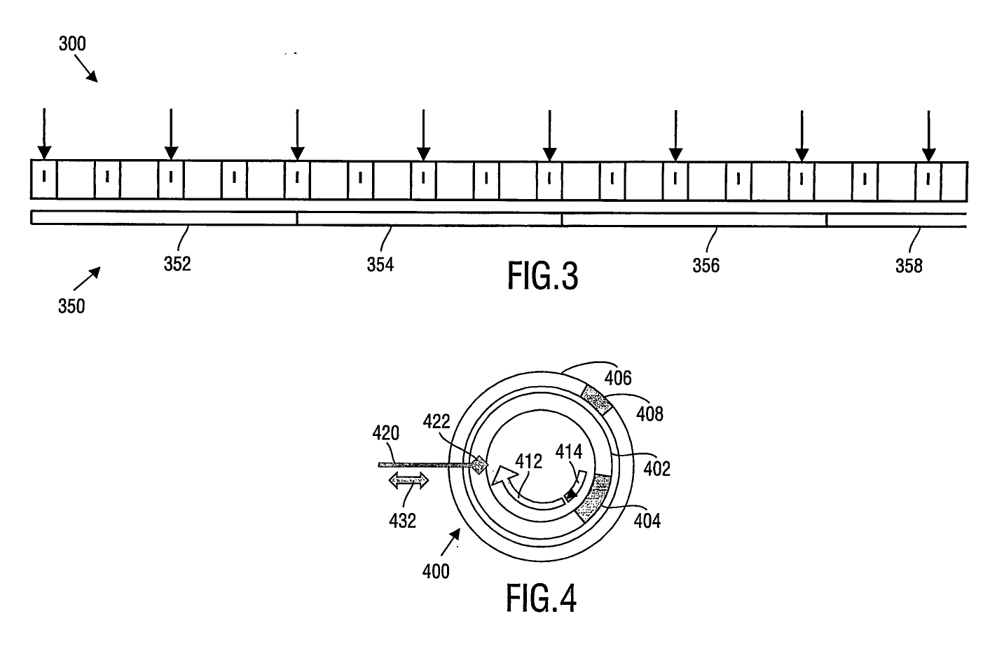

FIG. 3 illustrates the storage of a stream of audio-visual data in allocation units; and

FIG. 4 provides a schematic drawing of a disk with a pick-up unit to illustrate various timing parameters for determining the service time of a disk request.

FIG. 1 shows a consumer entertainment system 100 comprising a consumer electronics apparatus 110 as an embodiment of the apparatus according to the invention, a user control device 160 and a TV set 150.

The apparatus 110 comprises a storage device, preferably a harddisk drive 122 for storing audiovisual data, a processing unit 124 for controlling the apparatus, a Read Only Memory (ROM) 126 as an embodiment of the record carrier according to the invention for storing programme data for programming the processing unit 124, a DMA controller 128 for rapid data transfer from the harddisk drive 122 to a video rendering unit 130, comprised by the apparatus as well, and a user command controller 134 for receiving user commands. The ROM 126 can be implemented in various ways: solid state ROM, EEPROM, a magnetic data carrier, an optical data carrier or any other carrier.

The TV-set 150 comprises a screen 152. The TV-set is connected to the consumer electronics apparatus 110 by means of a first connector 132.

The user control device 160 comprises a play button 162, a rewind (fast backward) button 164 and a fast forward button 166 for controlling the direction and speed of playback of a stream of audiovisual data by the consumer electronics apparatus 110. The user control device 160 is connected to the consumer electronics apparatus 110 by means of a second connector 136. The connection may be either wired or wireless, this is irrelevant for the scope of the invention.

The consumer electronics apparatus 110 is intended for playback of streams of audiovisual data, stored in the harddisk drive 122. In another embodiment, this may just as well be an optical disk. The playback is initiated by a user command, for example pressing the play button 162. This generates a control signal in the user control device 160, received by the user command controller 134 and transmitted to the processing unit 124.

On reception of the control signal, the processing unit 124, programmed by a programme in the ROM 126, initiates retrieval of audiovisual data from the harddisk drive 122 and arranges transfer of the retrieved data to the video rendering unit 130 via the DMA controller 128. The video rendering unit 130 decodes the audiovisual data, which is in this embodiment compressed according to the MPEG (Motion Pictures Expert Group) 2 standard. The output of the video rendering unit is a video signal according to a known format (e.g. SECAM or PAL), presentable on the TV-set 150. The video signal is provided via the first connector 132.

FIG. 2 shows a stream 200 of compressed video data, compressed according to the MPEG 2 standard. The stream 200 is built up from compressed frames of three different types. They are grouped in a so-called Group Of Pictures or GOP. For this example, a GOP-size of six is taken, but the person skilled in the art will appreciate that also other GOP-sizes are allowed.

The ‘I’ frames are intracoded, which means that they can be decompressed using the proper decompression algorithm and data from the frame itself. The ‘B’ and ‘P’ frames are intercoded, which means that data from other (decoded) frames is needed as well to decompress those frames. For the decoding of compressed P-frames, data from the directly preceding I-frame is needed. For the decompression of B-frames, data from a preceding and/or succeeding I-frame or P-frame is needed.

Showing all pictures during normal real-time playback of the data renders a fluent video film on the display 152 (FIG. 1) of the TV-set 150 (FIG. 1), as all decoding as described in the previous paragraph can be done real-time. In case of fast playback of the video data, for example when a user presses the rewind button 164 or the fast forward button 166 during real-time playback, decoding all frames in synchronisation with the fast playback is not possible anymore. This is also not necessary, as in such a case more frames would be rendered than can be processed by the human eye and brain.

Therefore, usually only I-frames are rendered. For the stream 200 this would mean that for fast playback, a first I-frame 202, a second I-frame 204, a third I-frame 206 and a fourth I-frame 208 are combined to a trickplay stream 220. Playback of the trickplay stream 220 at the same frame rate of the stream 200 would result in a speed increase of a factor six. When all frames would be displayed trice as long, this would result in a speed increase of a factor two.

For higher rendering speeds, for example 12 time real time, rendering of some I-frames can be skipped and only a selected number of I-frames can be rendered. This is illustrated in FIG. 3, showing a stream 300. The stream 300 is compressed using the MPEG 2 standard. For the sake of simplicity, only the I-frames are indicated; the GOP-size is six (one I-frame with one P-frame and four B-frames after each I-frame). Since the GOP-size is six and every GOP has one I-frame, every second I-frame, indicated by arrows in FIG. 3, has to be rendered, wherein each frame is shown as long as during normal playback speed, thus realising the speed up factor of playback of 12.

For playback of audiovisual data, it is important that data is retrieved in time from the harddisk drive 122 (FIG. 1) and rendered in time by the video rendering unit 130 (FIG. 1).

To ensure delivery of data in time, data retrieval (and writing, which roughly takes the same amount of time for the same amount of data) is split up in so-called cycles of usually half a second to two seconds. For background information on cycle based scheduling of real-time requests, the reader is referred to the reference following this description. In a cycle period, several data retrieval requests can be scheduled. The data retrieval requests can be submitted by more than one application. For example, one application is taking care of the playback (and retrieval) of video data stored on the harddisk drive 122, whereas another application is taking care of periodically storing a user profile in the harddisk drive 122. Data handling (reading and writing of data; for the sake of clarity, retrieval will be used in the rest of the description, unless this would cause contradiction) of both requests can be scheduled in the same cycle.

This requires predictability of the time required for data and rendering. The processing speed of the video rendering unit 130 is usually rather predictable and the estimation is of less importance, for it is dedicated for rendering a stream and it does not have to perform other tasks. On the other hand, estimation of time needed for data retrieval from the harddisk drive 122 is more important. Reasons for this is that in a lot of cases, the harddisk drive 122 may also be used by applications other than video play-back, like storage of a user profile and that the time needed for retrieval of data for e.g. one I-frame is usually less predictable than the processing time needed by the video rendering unit for the rendering of the same I-frame.

Reasons for the difficulties in prediction of data retrieval are among others the probability for erroneous retrieval of data and fragmentation of data.

When data is retrieved erroneously—which can be detected with a redundancy check as known by a person skilled in the art—, a current art harddisk will perform a retry on data handling. This takes about the same time as the execution of a normal data retrieval request, increasing the total retrieval time with a factor two. If the second attempt succeeds, that is. Fortunately, current art harddisk drives have an error chance of 1 bit in 10¹⁴ whereas the storage capacity is in the order of 10¹² bits or 10¹¹ bytes. The storage of a high quality film of four hours consumes about 4% of this amount, making the odds of errors during retrieval (and playback) very low.

The issue of fragmentation, however, will occur more often. This is illustrated in FIG. 3 by a bar 350 below the stream 300. The bar 350 is a schematic representation of a part of the harddisk drive 122 and is divided in a first allocation unit 352, a second allocation unit 354, a third allocation unit 356 and a fourth allocation unit 358. Although the size of one allocation unit is larger than the size of one I-frame, it is still possible that one I-frame is stored in fragments over two allocation units. Furthermore, although the allocation units are drawn contiguously, they do not necessarily have to be located contiguously on the disk.

When the allocation units are not located contiguously on the disk, this causes the problem that for retrieval of one I-frame, data from two allocation units has to be retrieved. This means that for one data handling request, two disk requests have to be executed; with one disk request, data of at most one group of contiguous allocation units can be retrieved. As increase of retrieval time of an I-frame during trickplay will happen far more often than increase of retrieval time due to errors, it is important to model the increase of retrieval time due to fragmentation.

A simple but very rough estimation for the number of disk requests (or more generally, storage device requests) is to assume that every data object that has to be retrieved is fragmented and so to provide an upper bound that every file request takes two disk requests. Next, the number of disk requests is multiplied with the worst case time needed for execution of one disk request to obtain the worst case amount of time for execution of the file requests. Just as well, the average time needed for execution of one disk request can be used, but in that case, the calculation would yield the average time for execution of the file request. The components of this time factor will be elucidated further on in the description. For smaller allocation units and larger file requests, an upper bound is provided by expression 1.

Expression 1
[number of disk requests]≦[number of file requests]×(INT([maximum size of file request]/[size of allocation unit])+2)
Wherein the function INT(x) rounds the real number x down to the nearest integer number.

For larger sizes of allocation units and/or smaller sizes of file requests (or sizes of other data objects to retrieve, like I-frames in this example), the approach of multiplying the number of disk requests with a factor of 2 provides a very worst case upper bound. As can be seen from FIG. 3, only a relatively small amount of I-frames is fragmented when the allocation unit is sufficiently large. It should be noted, however, that the drawing of FIG. 3 is very schematic as only the I-frames are indicated and the rest of the GOP is illustrated small.

Inventors have appreciated that when data objects are stored at a substantially equal distance from each other and the size of the file requests (the size of the data chunks to retrieve) is smaller than the size of an allocation unit, according to an embodiment of the invention, a more accurate estimate of the number of disk requests and the worst-case time needed for execution of those disk requests can be provided than the one mentioned above, for the same amount of file requests.

For an MPEG 2 compressed videostream, the distance between I-frames (in bytes, so the logical distance) is substantially constant, as well as the size of the I-frames. Although MPEG 2 compression is a variable bit-rate compression algorithm, these distances can be fairly well estimated an at least an upper bound can be provided.

With knowledge of the size of I-frames, the distance between them and the size of an allocation unit, it can be estimated how many I-frames to be retrieved are stored unfragmented in one allocation unit and a lower bound can be provided for this. The estimate can be calculated by taking averages of the size of the I-frames and the distance between them; the lower bound can be calculated by taking worst case values: maximum size and:||-frames.

Next, an upper bound for the number of fragmented I-frames to be retrieved can be determined, as the total number of file requests is known, which is equal to the number of data objects to retrieve, and the lower bound of the number of unfragmented data objects is known. With the knowledge that the size of an allocation unit is substantially larger than the size of a data object, it can be deduced that a data object can be fragmented over at most two allocation units. This means that an upper bound for the number of disk requests can be calculated by taking the sum of the number of file requests and the upper bound of the number of fragmented data objects to be retrieved.

When average values of entities have been used to determine the amount of fragmented (or unfragmented) data objects to be retrieved, an estimate of the number of disk requests can be calculated.

A formula to calculate the worst case number of disk requests is provided with Expression 2 and Expression 3.

Expression 2
[number of disk requests]≦[number of file requests]+([number of allocation units involved]−1)
Wherein:
Expression 3
[number of allocation units involved]≦INT([number of file requests]×INT(([maximum distance]+[maximum size])/[size of allocation unit])+2)
This Can be Illustrated Using a Numerical Example:
GOP: 380 kB
I-frame size: 40 kB
Select every 2^{nd} I-frame for rendering;
Jump size (distance): 340 kB
Allocation unit size: 1024 kB
Frame rate: 4 frames per second
Cycle size: 2 seconds
File requests per cycle: 8
   [Number of allocation units involved]≦INT((8×(40+340)/1024)+2)=int(4.97)=4
   So the Maximum Number of Allocation Units Involved is Three Per Scheduling Cycle, Filling in Expression 2 Yields:
   [number of disk requests]≦8+4−1=11

FIG. 3, which provides a schematic representation of the case above, shows that four allocation units are involved indeed. The number of disk requests is for this case lower than the estimate. Only one requested file is fragmented, so the number of disk request is only one more than the number of file requests, i.e. nine. Nevertheless, the estimate of eleven file requests is a lot closer to nine than the estimate of 16 file requests that Expression 1 would yield.

Expressions 4 and Expression 5 provide for some cases an even more accurate estimate for the upper bound of the number of disk requests involved.

Expression 4
[number of disk requests]≦[number of file requests]+1+([number of file requests]−1)/([number of allocation units involved]+1)
Wherein:
Expression 5
[number of allocation units involved]≦INT(([size of allocation unit]−[maximum size file request])/([maximum distance]+[maximum size]))

Next, to properly schedule the disk requests for execution by the harddisk drive, the time needed for execution of one disk request is needed. This amount of time is built up from several components, of which the three most important will be discussed by means of FIG. 4. FIG. 4 shows a disk 400 of a harddisk drive with a first data track 402 comprising a first data portion 404 and a second data track 406 comprising a second data portion 408. FIG. 4 also shows an arm 420 with a read/write head 422.

A first arrow 432 indicates the seek time. This is the amount of time needed to position the read/write head of the harddisk drive to the first track 402 from which the first data block 404 has to be retrieved. For modern day harddisks, this is between 0 and 40 ms.

A second arrow 412 indicates the rotational delay. This is the amount of time needed to rotate the disk 400 to align the start of the first data portion 404 with the read/write head 422 to start retrieving the first data portion 404. For modern day harddisk with a rotational speed of 7200 rotations per minute, this is 8.3 milliseconds at most.

A third arrow 414 indicates the data retrieval time. This is the amount of time needed to actually retrieve the data to which the data retrieval was directed. This amount of time highly depends on the amount of data to be retrieved. In the cases as described above, where only one I-frame of 40 kB has to be retrieved at every disk request, this amount of time is relatively small.

For a very simplistic approach, the upper limit of the number of disk requests is multiplied with the worst case time required for execution of one disk request. This worst case time can be a sum of the three timing parameters mentioned in the previous paragraphs (or some of them), plus possibly other parameters (like the standard deviation of one, some or all parameters).

However, when data for multiple disk requests are located closely together, most probably less switch time is required. Various publications are available for a person skilled in the art describing more advanced models for estimating timing behaviour of execution of multiple disk requests. For the invention as a whole, however, it is not relevant which model is taken.

Although the invention has been described as to determine a worst case time for execution of a file request in a cycle-based scheduling algorithm, the invention can also be used for estimation of execution time and retrieval of data in data retrieval systems using other scheduling algorithms.

Embodiments of the invention have been described as an apparatus with one processing unit for carrying out embodiments of the method according to the invention. However, other embodiments of the apparatus according to the invention are possible wherein the various steps of embodiments of the method according to the invention are carried out by multiple processing blocks, without departing from the scope of the invention.

In a preferred embodiment of the invention, the invention is applied to handling of audiovisual data. The person skilled in the art will of course appreciate that the invention can also be applied to other types of data.

In summary, the invention relates to real-time handling of data in more in particular, estimation of time needed to retrieve frames for video rendering, taking fragmentation of frames into account. Especially for data retrieval for trick-play, this is non-trivial, as it is not known on beforehand whether the frames to be retrieved are fragmented. Retrieval of non-contiguously fragmented frames takes at least twice as much time as retrieval of a non-fragmented frame. The invention provides various advantageous embodiments, taking into account that when allocation units are substantially larger than the size of frames to be retrieved. An embodiment of the invention provides a method for accurate retrieval time estimation when trick play speed, allocation unit size, frame size and logical data distance between frames to retrieve is known.

### REFERENCE

J. Korst, V. Pronk and P. Coumans, Disk scheduling for variable-rate data streams, Philips Research Laboratories Eindhoven, The Netherlands, Proc. European Workshop on Interactive Distributed Multimedia Systems and Telecommunication Services, IDMS'97, 1997.

1. Method of handling a group of at least one data object by issuing a data handling request to be processed by a storage device organised in allocation units by execution of at least one storage device request in a pre-determined data handling period, the method comprising the steps of:
a) determining the number of data objects to be handled in the data handling period;
b) determining an upper boundary for the number of allocation units involved for the data handling request;
c) determining an upper boundary for the number of storage device requests by multiplying the number of data handling requests as determined in step a) and the upper boundary of the number of allocation units involved;
d) determining an upper boundary for an amount of time consumed by execution of the data handling request for handling the data objects during the data handling period by determining the amount of time needed for execution of the number of storage device requests as determined in the previous step;
e) reserving an amount of time as determined in the previous step in a data handling period for execution of the storage device requests; and
f) handling the data objects by executing the storage device requests.

2. Method according to claim 1, wherein
a) the maximum size of the data objects is substantially smaller than the size of allocation units;
b) the data objects are stored non-contiguously at a substantially equal logic distance from each other such that multiple data objects can be stored in one allocation unit;
c) the step of determining an upper boundary for the number of allocation units involved per data handling request is replaced by the step of determining an upper boundary of the number of data objects determined in step a) of claim 1 spaced at the substantially equal logic distance that is stored fragmented; and
d) the step of determining an upper boundary for the number of storage device requests is replaced by the step of taking the sum of the number of data handling requests and the number of data objects determined in step c) of this claim.

3. Method according to claim 1, wherein the method comprises the steps of:
a) determining the size of one allocation unit;
b) determining the maximum size of a data object; and
wherein the upper boundary for the number of allocation units involved is determined by the following expression:
[number of allocation units involved]≦[maximum size of a data object]/[size of one allocation unit]+2

4. Method according to claim 2, wherein the method comprises the steps of:
a) determining the maximum distance between the data objects;
b) determining the size of one allocation unit;
c) determining the maximum size of a data object; and
wherein the upper boundary for the number of allocation units involved is determined by the following expression:
[number of storage device requests]≦[number of data handling requests]+([number of allocation units involved]−1)
wherein is the upper boundary of the number of allocation units involved in execution of the data handling requests is determined by the following relation:
[number of allocation units involved]≦([number of data handling requests]×([maximum distance]+[maximum size])/[size of allocation unit])+2

5. Method according to claim 1, wherein the data objects are video frames comprised by a stream of audiovisual data.

6. Method according to claim 5, wherein the stream of audio-visual data comprises inter-coded and intra-coded frames.

7. Method according to claim 6, wherein the multiple data objects to which the data handling requests are related are at least some of the intra-coded frames

8. Method according to claim 1, wherein step d) comprises the step of multiplying the upper boundary for the number of storage device requests by an amount of time consumed by a storage device request.

9. Method according to claim 8, wherein the amount of time is pre-determined.

10. Method according to claim 1, wherein the storage device is a disk drive and the determination of the upper bound for the amount of time further takes into account at least one of the following parameters:
a) the amount of time required for one revolution of a disk;
b) the seek time of a pick-up unit of the disk drive to a location on a disk where a data object is located to which the data handling request is aimed; and
c) the time needed to retrieve the data object to which the data handling request is aimed.

11. Method according to claim 2, wherein the storage device is a disk drive and the determination of the upper bound for the amount of time further takes into account at least one of the following parameters:
a) the amount of time required for one revolution of a disk;
b) the seek time of a pick-up unit of the disk drive to a first location on a disk where a first data object is located to which the data handling request is aimed; and
c) the time needed to retrieve the data object to which the first data handling request is aimed; and
d) the time needed for the pick-up unit to move from the first location on the disk to a second location on the disk where a second, subsequent data object is located to which the data handling request is aimed.

12. Method according to claim 1, wherein the determination of the upper boundary for the number of allocation units involved per data handling requests comprises the step of dividing the size of the data object by the size of one allocation unit.

13. Apparatus for handling a group of at least one data object by a data handling request to be processed by at least one storage device request handled in data handling periods, the data handling to be performed by a storage device organised in allocation units, the apparatus comprising a central processing unit conceived to:
a) determine the number of data objects to be handled per data handling period;
b) determine an upper boundary for the number of allocation units involved per data handling request;
c) determine an upper boundary for the number of storage device requests by multiplying the number of data handling requests by the upper boundary of the number of allocation units involved;
d) determine an upper boundary for an amount of time consumed by execution of the storage device requests for handling the data objects during one data handling period by multiplying the upper boundary for the number of storage device requests by an amount of time consumed by a storage device request;
e) reserve an amount of time as determined in the previous step in a data handling period for execution of the storage device requests; and
f) handle the data objects by executing the storage device requests.

14. Computer programme product enabling a computer to be programmed to execute the method according to claim 1.

15. Record carrier carrying computer programme product according to claim 14.

16. Programmed computer enabled to execute the method according to claim 1.
